(19) United States
(12) Patent Application Publication
(10) Pub. No.: US 2021/0165111 A1
(43) Pub. Date: Jun. 3, 2021

(54) METHOD FOR DETERMINING THE POSITION OF A VEHICLE

(71) Applicant: CONTINENTAL TEVES AG & CO OHG, Frankfurt am Main (DE)

(72) Inventor: Michael ZALEWSKI, Frankfurt am Main (DE)

(21) Appl. No.: 17/045,432

(22) PCT Filed: Mar. 19, 2019
(86) PCT No.: PCT/EP2019/056747

§ 371 Date: Oct. 5, 2020

(30) Foreign Application Priority Data
Apr. 6, 2018 (DE) 10 2018 205 205.0

(51) Int. Cl. G01S 19/47; G01S 19/23

(52) U.S. Cl. CPC G01S 19/47; G01S 19/235

(57) ABSTRACT

A method for determining the position of a vehicle by way of a sensor unit (IMU), a receiver device for receiving signals of a satellite of a satellite navigation system, and an electronic filter device includes receiving satellite data of a satellite by way of the receiver device and sensor data by way of the sensor unit (IMU),
feeding the sensor data and the satellite data to the filter device,
converting the satellite data by way of the filter device to a reference point which corresponds to the position of the sensor unit (IMU), and
determining the position of the vehicle by way of the filter device by filtering and/or fusing the satellite data and the sensor data.

### FIELD

The invention relates to a method for determining the position of a vehicle and a corresponding apparatus.

### BACKGROUND

New functions increasingly need more precise information regarding the position and regarding the orientation of a vehicle.

For localization by way of a global satellite navigation system, pseudo routes between the respective satellites and a receiver device can be established by way of code measurements, and differences in route between the various satellites and the receiver device can be established by way of carrier phase measurement, and the position of the receiver can be calculated. For the establishment of the pseudo routes, the distance between the phase center of the receiver device or respectively the GNSS antenna and the phase center of the satellite antenna is determined by propagation time measurement. The phase center of an antenna is a virtual point, to which the measurement refers and which usually has a directional dependence and can, in addition, be arranged by a few meters in the space around the antenna, the so-called phase center variation. Due to the various positions of the satellites, this can therefore result in a deviating phase center, sometimes considerably, of the GNSS antenna for each satellite as well. So as not to negatively influence the GNSS position establishment, the GNSS satellites transmit correction terms for the virtual phase center of the respective satellite antenna, in order to be able to correct these effects.

The usual measurement accuracy with code measurement is currently in the range of a few meters, which is why a GNSS antenna can be used, the phase center of which has a scattering in the range of centimeters to decimeters and is therefore not of essential importance for the evaluation. The accuracy of this type of GNSS receiver is insufficient for future functions.

Precisely measured antennas without significant directional dependence as well as more powerful processing electronics are accordingly deployed for more precise applications, wherein an accuracy in the millimeter range can be achieved, for example by way of carrier phase measurement. In order to calibrate, the phase center is measured under laboratory conditions over as large as possible a solid angle around the antenna, wherein a transmitter supplies the antenna with a test signal from different directions. In connection with this, the position and orientation of the antenna and transmitter are known. As a result, the position of the phase center, for example relative to the antenna reference point (ARP), the so-called phase center offset, can be established as a function of the direction of incidence, which position is used to correct the directional dependence of the phase center during the establishment of the position. Alternatively or additionally, GNSS receivers can be designed, involving high expenditure, such that they have a very small phase center variation of less than one centimeter. By way of additional measurements and corrections, the measuring accuracy can be increased into the sub-millimeter range. The disadvantage is that correspondingly high-quality GNSS receivers or antennas are very costly and, therefore, are not considered for mass production, in particular in the vehicle supply industry which is subjected to high cost pressure.

A calibration method for determining correction information for a receiver device or antenna of a vehicle is known from the application having application number 10 2017 222 912.8 submitted to the German Patent and Trade Mark Office (which had not yet been published at the time of this application).

In order to improve the determination of the vehicle position, the process of using sensor data of a sensor unit, for example of an inertial measuring unit (IMU), and fusing said sensor data with the satellite data thus reducing the error of the position establishment, is known. If this is caused in accordance with a loosely coupled algorithm, data finally provided by the receiver device such as the position, speed, and/or time are used, whereas the data fusion is caused, for example, in the case of a tightly coupled algorithm or algorithm having a close coupling, by way of raw data, for example pseudo routes or carrier signal phases. Signals do not have to be present from at least four satellites, as in the case of the data finally provided. Instead, in the case of a tightly coupled algorithm, fewer satellites are sufficient, since the satellite signals are individually used for data fusion. Corrections with regard to the receiver device are, however, not provided, which is why the accuracy is restricted.

### SUMMARY

It is therefore an object of the invention to indicate a method for determining the position of a vehicle, which makes possible a high or improved accuracy with as inexpensive a receiver device as possible.

This object is achieved by the subject-matter of the independent claims. Preferred embodiments of the invention are the subject-matter of the dependent claims and the description.

According to an aspect of the invention, a method for determining the position of a vehicle by way of a sensor unit, a receiver device for receiving signals of a satellite of a satellite navigation system, and an electronic filter device comprises the steps of:

receiving satellite data of at least one satellite by way of the receiver device and receiving or capturing sensor data by way of the sensor unit,

feeding or providing the sensor data and the satellite data to the filter device,

converting the satellite data by way of the filter device to a reference point which preferably corresponds to the position of the sensor unit,

determining the position of the vehicle by way of the filter device by filtering and/or fusing the satellite data and the sensor data.

The concept which forms the basis of the present disclosure is that the determining of the position of the vehicle by way of the filter device by filtering and/or fusing the satellite data and the sensor data, despite a possibly necessary correction of system-related errors, should take place with a common reference point, so that the result is not falsified. This is preferably the position of the sensor unit.

The satellite data are preferably raw data, in particular pseudoranges or pseudo routes (pseudoranges) and/or carrier signal phases (carrier phases & delta ranges) and the satellite positions calculated from ephemeris data of the respective satellites. Before they are converted, the satellite data are based on the phase center of the receiver device.

According to an aspect, the satellite data are converted by way of the filter device to the reference point starting from a phase center of the receiver device, preferably directly, that is to say without intermediate steps. Consequently, the offset is corrected between the phase center of the receiver device depending on the satellite position and orientation of the receiver device and the reference point of the data fusion. The concept which forms the basis of this further development is that corrections of this type would normally be performed by the receiver device, however the latter is missing the necessary information regarding the distance and the direction of the phase center in relation to the reference point, since these are separate devices. It is true that it would be possible to link both with one another, however this would lead to time differences which would falsify the further calculations.

Alternatively, it is possible that the receiver device carries out a correction to the effect that it performs a conversion first to the antenna reference point of the receiver device. The antenna reference point is a reference point of the receiver device which can be established in the global coordinate system, frequently at the lowest point of the antenna body on the central axis. However, the data already thus transformed would then have to be displaced again to the reference point relevant to the data fusion. In addition, additional interference effects are created if the antenna correction is already introduced by means of the receiver device.

In one aspect, an offset between the reference point and the phase center is corrected by way of the conversion of the filter device. In one aspect, this is caused by including the distance in the direction spanned by these points in the satellite data. Accordingly, the signal phase or the pseudo distance between the satellite and receiver device changes, for example, for the further calculation.

In accordance with an advantageous further development, in order to establish the phase center, a calibration is performed depending on the location of the satellite relative to the location and the alignment of the receiver device and/or of the vehicle. In this case, the necessary correction in each case is determined for various constellations according to one aspect, that is to say reciprocal alignments and positions of the receiver device and satellite. According to an aspect, the correction is established and stored as the correction from the respective phase center to the reference point which corresponds to the position of the sensor unit.

The calibration, in one aspect, comprises the steps of:

establishing first distance information of the receiver device in relation to a satellite of a satellite navigation system,

capturing position information and orientation information of the receiver device on the basis of sensor information,

establishing second distance information of the receiver device in relation to the satellite on the basis of the position information captured by means of sensor information,

determining a deviation of the first distance information from the second distance information,

establishing correction information on the basis of the determined deviation, and

storing the correction information regarding the orientation information captured by means of the sensor information, in particular the location and alignment of the receiver device, in an electronic data memory.

The concept which forms the basis thereof is that by using distance information of the receiver device in relation to a satellite, which is obtained in different ways, and taking account of the orientation, an estimation of correction information in order to compensate for the offset of the angle-dependent phase center of the receiver device can be produced. Orientation information in this sense is, in one aspect, an orientation of the receiver device in particular with respect to information describing a global coordinate system. In satellite navigation systems, the respective satellite positions are usually transferred with the ephemerides such that these positions can, in principle, be assumed to be known. The first distance information can, for example, be detected with the aid of the signal propagation time of the data transferred by the satellite to the antenna or as the receiving intensity of the signal. Accordingly, the comparability of the distance information is of interest, in one aspect. Accordingly, an absolute distance value in relation to the satellite does not necessarily have to be taken as the basis. For example, a receiving intensity can also be compared with an expected receiving intensity. Distance information is present in both. This procedure is already known for global satellite navigation systems. The calibration can, in one aspect, be effected at least partially during a calibration journey with a vehicle having the antenna or in a laboratory, wherein the receiver device receives signals radiated from navigation satellites under laboratory conditions.

If a direction-dependent offset of the phase center exists, a different phase center offset value is produced at the given alignment of the receiver device for each received satellite signal, which phase center offset value can be accordingly compensated for with the knowledge thereof. The method according to the disclosure is accordingly expediently performed for a plurality of satellites of one or more satellite navigation systems. On the basis of the satellite position transferred with the ephemerides, there exists the possibility, with the acquired knowledge of the orientation and determined direction-dependent correction parameters, of taking account of the receiving direction of each satellite with respect to the directional dependence of the phase center offset.

It is preferred, in one aspect, that the location of the phase center is inferred, depending on the location of the satellite relative to the location and the alignment of the receiver device and/or of the vehicle, from an electronic data memory.

In accordance with a further development according to an aspect, the location of the phase center is interpolated, starting from a current location of the satellite relative to the location and the alignment of the receiver device, to the time which corresponds to the receipt of the satellite data by way of the receiver device. Consequently, the location of the phase center for the conversion or transformation is synchronized with the time of the receipt of the satellite data. The advantage of this is that due to said interpolation which is expediently directed backwards in time, the location of the phase center may be established less frequently.

The sensor unit is, in one aspect, configured to capture measuring data of the driving dynamics, in particular acceleration and/or rotation rate data of the vehicle around the main axes. The sensor unit, in one aspect, comprises an inertial measuring device. The sensor data output by the sensor unit, in particular driving dynamics data, can include longitudinal accelerations, lateral accelerations, vertical accelerations, yaw rates, roll rates and/or pitch rates. Said sensor data are preferably used in order to increase the information content of the satellite data and, for example, to precisely define the position and the speed of the vehicle on a road. The sensor data may also include, in accordance with a further development according to an aspect, odometry data or the sensor data can be supplemented by these. Odometry data describe an assessment of the position and orientation of a vehicle with the aid of its propulsion system and include, for example, the wheel rotation angle momentum and the steering angles of individual wheels output by a controller or sensor.

The satellite data are, in one aspect, raw data; in particular, the satellite data and the sensor data are filtered by way of a tightly coupled, deeply coupled, ultra-tightly coupled or another algorithm and not with a loosely coupled algorithm which does not use any raw data, but information which has already been processed, for example, to position or speed data in the global coordinate system.

The application of the method in the case of a deeply coupled algorithm of the filter device makes it possible, by installing the correct lever arms and different phase centers, in accordance with different signal propagation times, to actuate the tracking loops in a more targeted manner, as a result of which it is possible to measure in phase. This shortens the drop-out time following signal interruption compared with measurements which are not converted from the phase center to the reference point, which then have to measure out of phase and build up again.

In one aspect, the satellite data are values of a pseudo distance between the satellite and receiver device and/or the phasing of the signal present at the receiver device. The method is, in one aspect, applied in connection with a PPP (Precise Point Positioning) method or RTK (Real-Time Kinematic) method.

In accordance with a further development, the receiver device is configured to receive data of a reference station, wherein the method includes all of the steps concerning the satellite data for data of the reference station as well. Instead of or in addition to satellite data, data from reference stations, in particular geodetic receivers or respectively dual-frequency receivers for GNSS satellite systems can be processed according to a real-time kinematic system (RTK) with the method according to an aspect of the disclosure.

The converting of the satellite data by way of the filter device to a reference point which corresponds to the position of the sensor unit is, in one aspect, repeated multiple times or in a loop-like manner. Accordingly, it is therefore conceivable that a measurement or a receipt of satellite data is performed with multiple receiver devices, without these having to have the same location and the same alignment relative to the reference point. Therefore, according to an advantageous further development, more than one receiver device is used, wherein each of the receiver devices carries out the steps of:

receiving satellite data of a satellite,

feeding the satellite data to the filter device.

This is advantageous in terms of the reliability, redundancy or also precision of the establishment of the position. Multiple receiver devices are also particularly advantageous in that if the satellite data are directly converted by way of the filter device to the reference point, starting from a phase center of the receiver device, the method remains the same in principle and does not require any adaptation for the various receiver devices since it does not fundamentally matter how large the distance is between the phase center of the respective receiver device and the reference point.

In one aspect, a vehicle orientation is determined on the basis of the sensor data, the satellite data and the offset between the reference point and the phase center.

The satellite data are, in one aspect, transformed or converted exclusively by way of the filter device, that is to say this is not also additionally performed in other submodules. This increases the availability, accuracy and consistency at the same time as reducing the computational expense. In accordance with a further development, a conversion of the satellite data by means of the filter device to the reference point, starting from a phase center, is used multiple times, i.e. individually and independently for each satellite signal, for determining the position of the vehicle.

Furthermore, the invention relates to an apparatus for determining the position of a vehicle, configured to perform at least one embodiment of the method according to the present disclosure, comprising a sensor unit, a receiver device for receiving signals of a satellite of a satellite navigation system, and an electronic filter device.

The apparatus, in one aspect, includes a processor which is configured to establish a geographical position of the vehicle with the aid of signals from satellites received by way of the receiver device. The processor can alternatively or in addition be embodied to establish the orientation of the vehicle, using sensor signals and/or the satellite signals.

According to an aspect, the apparatus is embodied to receive and to process NAVSTAR GPS, GLONASS, GALILEO and/or BEIDOU satellite signals.

According to an aspect, the apparatus further includes an electronic data memory for saving data.

The apparatus can be mounted in cars, in airplanes or in ships.

### BRIEF DESCRIPTION OF THE DRAWINGS

The present disclosure will be explained in greater detail below with reference to an example embodiment, wherein, in a considerably schematized representation:

FIG. 1 shows the influence of various phase centers during cornering; and

FIG. 2 shows a receiver device and a satellite of a satellite navigation system.

### DETAILED DESCRIPTION OF THE DRAWINGS

In the case of a GNSS system, the satellite position is in principle transferred with the ephemerides. The position of the vehicle and, consequently, also the receiving direction can be established from these values with the aid of the pseudo route between the satellite and the vehicle. A very simplified conventional calculation basis for a pseudo route PSRARP of a satellite to the antenna reference point ARP is depicted below.

Azimuth=150°; elevation=30°

Pseudo route (PSR)=22123,456.400 m

Phase center offset (PCO)=1.45 m

PSRARP=PSR−PCO=22123,456.400 m−1.45 m=22123,454.950 m

During the journey of the car, the orientation of the receiver device based on a satellite changes e.g. during cornering, and another correction value is selected for example for the azimuth, such that an offset of the phase center (phase center offset (PCO)) that deviates from the above is produced for the respective satellite. For example, the vehicle turns 10° to the left, wherein the elevation remains the same and the azimuth rises:

Azimuth=160°; elevation=30°

PSR=22123,456.400 m

Phase center offset (PCO)=1.7 m

PSRARP=PSR−PCO=22123,456.400 m−1.70 m=22123,454.700 m

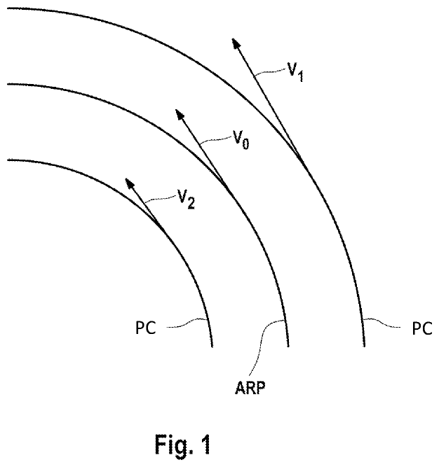

In FIG. 1 it is depicted how, during cornering of the vehicle, depending on whether the phase center PC relative to the antenna reference point ARP lies further inside the corner or outside the corner, the values for the distance covered, speed and direction of movement thus captured change. It is understood that, depending on the location of the satellite, only one of the two depicted phase centers PC occurs. Accordingly, if no correction is performed, falsified information is created, which is not sufficient for applications which require a high degree of precision.

If a direction-dependent offset of the phase center PC exists, a different offset value is produced at the given alignment of the receiver device for each received satellite signal, which offset value can be accordingly compensated for with knowledge of the phase center offset. This calculation can be performed with loosely coupled algorithms for each received satellite such that all pseudo route measurements refer to the same antenna reference point (ARP). With these corrected data, a more precisely defined establishment of the ego position could be effected. If such antenna corrections are used, these are conventionally implemented in the receiver device which can carry out a more precise establishment of the position with such a correction.

In the case of a corresponding algorithm, for example a tightly coupled algorithm, which is executed in the filter device and which does not utilize any position data already established by the receiver device, but utilizes the GNSS raw data of navigation satellites, an antenna correction is not, however, easily possible.

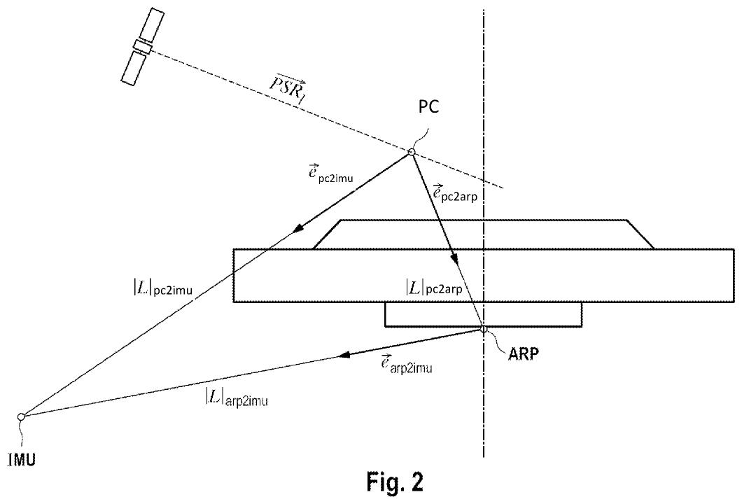

Calculation steps for converting satellite data to a reference point are schematically illustrated in FIG. 2.

As already explained above, it is possible to correct the offset of a current phase center PC by subtracting the offset out with respect to the antenna reference point ARP. To this end, the current phase center PC which is dependent, inter alia, on the satellite position must be known by means of a calibration method. In the case of an algorithm in the filter device, which uses GNSS raw data and fuses the latter with sensor data, for example of an inertial measuring unit, it does however make sense according to the present disclosure to have a common reference point for the fusion, which corresponds to the location of the sensor unit IMU and, thus, to the location to which the sensor data refer, such that the computational expense is kept within reasonable limits.

If the error resulting due to the offset of the phase center PC with respect to the antenna reference point ARP is compensated for by way of the receiver device, the reference point, however, lies in the antenna reference point ARP and not where it should expediently lie, namely at the point where the sensor unit IMU is located. With a lever arm |L|_pc2arp in the direction of e_pc2arp, which is known from a previously performed calibration method, the antenna correction for the pseudo route PSR_i, the direction of which is known by means of the ephemeris data, is calculated as

[symbol]

+|L|_{pc2arp}*\vec{e}_{pc2arp}.

The thus transformed data, according to an aspect, must accordingly be transformed again, this time however from the antenna reference point ARP to the reference point IMU. For this calculation, however, the receiver device is missing the information regarding the distance and direction from the antenna reference point ARP to the reference point IMU, |L|_arp2imu and e_arp2imu. In addition, additional interference effects are created, if the antenna correction is already performed at the level of the receiver device, since the vehicle orientation is not available here or is only available here with reduced accuracy.

Advantageously, the entire transformation or conversion

[symbol]

+|L|_{pc2arp}*\vec{e}_{pc2arp}+|L|ₐᵣₚ₂ᵢₘᵤ*\vec{e}ₐᵣₚ₂ᵢₘᵤ

is therefore implemented and executed in the filter device.

|L|_arp2imu multiplied by e_arp2imu corresponds to a fixed value which depends on the arrangement in the vehicle remaining the same, that is to say it is constant. Accordingly, the calculation can be further simplified to

[symbol]

+|L|_{pc2imu}*\vec{e}_{pc2imu}.

Thanks to the conversion in the filter unit instead of the receiver device, an antenna correction is consequently also possible if GNSS raw data are used during the fusion with sensor data. The method is independent of whether the phase center of the receiver device is only a few millimeters or a few meters away from the antenna reference point ARP.

The indicated steps of the method according to the present disclosure can be executed in the indicated order. They can, however, also be executed in another order. The method according to the present disclosure can be executed in one of its embodiments, for example with a determined set of steps, such that no further steps are executed. However, further steps can in principle also be executed.

1. A method for determining the position of a vehicle by way of a sensor unit (IMU), a receiver device for receiving signals of at least one satellite of a satellite navigation system, and an electronic filter device, the method comprising the steps of:
receiving satellite data of a satellite by way of the receiver device and sensor data by way of the sensor unit (IMU),
feeding the sensor data and the satellite data to the filter device,
converting the satellite data by way of the filter device to a reference point which corresponds to a position of the sensor unit (IMU), and
determining the position of the vehicle by way of the filter device by filtering and/or fusing the satellite data and the sensor data.

2. The method according to claim 1, wherein the satellite data are converted by way of the filter device to the reference point starting from a phase center (PC) of the receiver device.

3. The method according to claim 2, wherein an offset between the reference point and the phase center (PC) is corrected by way of the conversion of the filter device.

4. The method according to claim 2, wherein, in order to establish the phase center (PC), a calibration is performed depending on the location of the satellite relative to a location and an alignment of the receiver device and/or of the vehicle.

5. The method according to claim 4, wherein the calibration comprises the steps of:
establishing first distance information of the receiver device in relation to a satellite of a satellite navigation system,
capturing position information and orientation information of the receiver device on the basis of sensor information,
establishing second distance information of the receiver device in relation to the satellite on the basis of the position information captured by way of sensor information,
determining a deviation of the first distance information from the second distance information,
establishing correction information on the basis of the determined deviation, and
storing the correction information regarding the orientation information captured by way of the sensor information, wherein the orientation information includes the location and alignment of the receiver device, in an electronic data memory.

6. The method according to claim 2, wherein a location of the phase center (PC) is inferred, depending on a location of the satellite relative to a location and an alignment of the receiver device and/or of the vehicle, from an electronic data memory.

7. The method according to claim 6, wherein the location of the phase center (PC) is interpolated, starting from a current location of the satellite relative to the current location and the alignment of the receiver device, to a time which corresponds to receipt of the satellite data by way of the receiver device.

8. The method according to claim 1, wherein the sensor unit (IMU) is configured to capture measuring data of driving dynamics, wherein the driving dynamics include acceleration and/or rotation rate data of the vehicle.

9. The method according to claim 1, wherein the satellite data are raw data, wherein the satellite data and the sensor data are filtered by way of a tightly coupled or deeply coupled or ultra-tightly coupled algorithm.

10. The method according to claim 1, wherein the satellite data are values of a pseudo distance between the satellite and the receiver device and/or phasing of a signal present at the receiver device.

11. The method according to claim 1, wherein the receiver device is configured to receive data of a reference station, wherein the method comprises all of the steps concerning the satellite data for the data of the reference station.

12. The method according to claim 1, wherein more than one receiver device is used, wherein each of the receiver devices carries out the steps of:
receiving satellite data of a satellite, and
feeding the satellite data to the filter device.

13. The method according to claim 2, wherein a vehicle orientation is determined on the basis of the sensor data, the satellite data, and an offset between the reference point and the phase center (PC).

14. The method according to claim 2, wherein a conversion of the satellite data by means of the filter device to the reference point, starting from a phase center (PC), is used multiple times for determining the position of the vehicle.

15. An apparatus for determining a position of a vehicle, the apparatus comprising:
a sensor unit (IMU),
a receiver device for receiving signals of a satellite of a satellite navigation system, and
an electronic filter device,
wherein the receiver device provides satellite data of the satellite,
wherein the sensor unit (IMU) provides sensor data,
wherein the filter device receives the sensor data and the satellite data,
wherein the filter device converts the satellite data to a reference point which corresponds to a position of the sensor unit (IMU), and
wherein the position of the vehicle is determined by the filter device, wherein the filter device filters and/or fuses the satellite data and the sensor data.

16. The apparatus according to claim 15, wherein the filter device converts the satellite data to the reference point starting from a phase center (PC) of the receiver device.

17. The apparatus according to claim 16, an offset between the reference point and the phase center (PC) is corrected by way of the conversion of the filter device.

18. The apparatus according to claim 16, wherein, in order to establish the phase center (PC), a calibration is performed depending on the location of the satellite relative to a location and an alignment of the receiver device and/or of the vehicle.

19. The apparatus according to claim 15, wherein the satellite data are raw data, wherein the satellite data and the sensor data are filtered by way of a tightly coupled or deeply coupled or ultra-tightly coupled algorithm.

20. The apparatus according to claim 15, wherein the satellite data are values of a pseudo distance between the satellite and the receiver device and/or phasing of a signal present at the receiver device.
